(19) United States
(12) Patent Application Publication
(10) Pub. No.: US 2021/0144167 A1
(43) Pub. Date: May 13, 2021

(54) APPARATUS AND METHOD FOR DETECTING AN ANOMALY IN A DATASET AND COMPUTER PROGRAM PRODUCT THEREFOR

(71) Applicant: HUAWEI TECHNOLOGIES CO., LTD., SHENZHEN (CN)

(72) Inventors: Valery Nikolaevich GLUKHOV, Moscow (RU); Liang Zhang, Nanjing (CN); Jiyu Pan, Beijing (CN)

(21) Appl. No.: 17/152,019

(22) Filed: Jan. 19, 2021

Related U.S. Application Data
(63) Continuation of application No. PCT/CN2018/096425, filed on Jul. 20, 2018.

(51) Int. Cl. H04L 29/06; G06N 7/00; G06F 16/2457; G06K 9/62

(52) U.S. Cl. CPC H04L 63/1425; G06N 7/005; G06K 2009/6294; G06F 16/24578; G06K 9/6288; H04L 63/1433

(57) ABSTRACT

Apparatus and methods for detecting an anomaly in a dataset by using two or more anomaly detection algorithms, as well as to corresponding computer program products, are described. The results obtained by using the two or more anomaly detection algorithms are combined in accordance with a certain rule of combination, thereby providing an improved accuracy of anomaly detection.

### CROSS-REFERENCE TO RELATED APPLICATIONS

This application is a continuation of International Application No. PCT/CN2018/096425, filed on Jul. 20, 2018, the disclosure of which is hereby incorporated by reference in its entirety.

### TECHNICAL FIELD

The present disclosure relates to the field of data processing, and more particularly to an apparatus and method for detecting an anomaly in a dataset by using two or more anomaly detection algorithms, as well as to a corresponding computer program product.

### BACKGROUND

Anomaly detection refers to identifying data items that do not conform to an expected behavior pattern or do not correspond to other (e.g., normal) data items in a dataset. Anomaly detection algorithms are being currently used for a variety of purposes, such, for example, as fraud detection in stock markets, malicious activity detection in computer or communication networks, malfunction detection in software or hardware, disease detection in medicine, etc.

Anomalies may be conveniently divided into those which are relevant to an event of interest, and those which are irrelevant to the event of interest. The latter anomalies, also known as spurious anomalies, may have a negative impact on user experience, resulting in false alarms, and therefore have to be excluded from consideration when searching for the former anomalies in the dataset. To this end, a particular anomaly detection algorithm may be applied to calculate a specified number of top anomalies and visualize the top anomalies in the descending order of anomaly importance, thereby allowing a user to manually filter out the spurious anomalies. However, such manual work is time consuming and requires solid knowledge in a certain usage domain.

To reduce a false alarm rate, two or more anomaly detection algorithms may be used in concert with each other to provide an average anomaly score for each data item in a dataset of interest. As for the manual work, it may be avoided, at least partly, by combining the anomaly detection algorithms with conventional machine learning techniques, such as unsupervised learning and supervised learning. In the meantime, all known anomaly detection systems do not provide a sufficient accuracy, and still rely on user-defined rules which may vary depending on a certain usage domain.

Therefore, there is still a need for a new solution that allows mitigating or even eliminating the above-mentioned drawbacks peculiar to the prior approaches.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

It is an object of the present disclosure to provide a technical solution for improving the accuracy of anomaly detection, and minimizing user involvement.

The object above is achieved by the features of the independent claims in the appended claims. Further embodiments and examples are apparent from the dependent claims, the detailed description and the accompanying drawings.

According to a first aspect, an apparatus for detecting an anomaly in a dataset is provided. The apparatus comprises at least one processor, and a storage coupled to the at least one processor and storing executable instructions. The instructions, when executed, cause the at least one processor to receive the dataset comprising multiple data items among which at least one data item is anomalous, and select at least two anomaly detection algorithms. The at least one processor is then instructed, by using each of the at least two anomaly detection algorithms, to: calculate an anomaly score for each of the data items; based on the anomaly scores, obtain a partial ranking of the data items, the partial ranking causing the data items to be divided into subsets each corresponding to a different interval of intermediate ranks; based on the partial ranking, select a probabilistic model describing the intermediate ranks of the data items in each subset; and based on the probabilistic model, assign a degree of belief to the intermediate rank of each of the data items in each subset. The at least one processor is next instructed to obtain a total degree of belief for the intermediate rank of each of the data items by combining the degrees of belief obtained, for this intermediate rank, by using all of the at least two anomaly detection algorithms in accordance with a predefined combination rule. After that, the at least one processor is instructed to convert the total degrees of belief for the intermediate ranks of the data items to a probability distribution function describing expected ranks of the data items. The at least one processor is further instructed to sort the data items according to the expected ranks of the data items, and find the at least one anomalous data item among the sorted data items. By doing so, it is feasible to detect anomalies in more accurate and robust manner, without having to use expert rules specific to a particular knowledge domain.

In an embodiment form of the first aspect, the at least one processor is configured to select the at least two anomaly detection algorithms based on a usage domain which the data items belong to. This provides flexibility in use because the apparatus according to the first aspect can equally operate in different usage domains.

In a further embodiment form of the first aspect, each of the at least two anomaly detection algorithms is provided with a different weight coefficient, and the at least one processor is further configured to assign the degree of belief based on the probabilistic model in concert with the weight coefficient of the anomaly detection algorithm. By assigning the different weight coefficients to the anomaly detection algorithms, one can obtain a more objective degree of belief for the intermediate rank of each of the data items in each subset.

In a further embodiment form of the first aspect, the at least two anomaly detection algorithms are unsupervised learning based anomaly detection algorithms, and the different weight coefficients of the at least two anomaly detection algorithms are specified based on user preferences such that the sum of the weight coefficients is equal to 1. By doing so, it is feasible to minimize the user involvement in anomaly detection, i.e. to make the apparatus according to the first aspect more automatic.

In a further embodiment form of the first aspect, the at least two anomaly detection algorithms are supervised learning based anomaly detection algorithms, and the weight coefficients of the at least two anomaly detection algorithms are adjusted by using a pre-arranged training set comprising different previous datasets and target rankings each corresponding to one of the previous datasets. By doing so, it is feasible to minimize the user involvement in anomaly detection.

In a further embodiment form of the first aspect, when the supervised learning based anomaly detection algorithms are used, the weight coefficients of the at least two anomaly detection algorithms are further adjusted based on the Kendall tau distance. The Kendall tau distance serves a measure of distance between the combined partial rankings obtained by the at least two anomaly detection algorithms and respective one of the target rankings from the training set. With the Kendall tau distance, the contribution of each anomaly detection algorithm is adjusted more efficiently.

In a further embodiment form of the first aspect, the subsets obtained based on the partial ranking of the data items comprises at least two first subsets each comprising the data items having the same anomaly scores. This allows the data items to be separated into multiple anomaly classes in a simple and efficient manner.

In a further embodiment form of the first aspect, the intervals of intermediate ranks of the at least two first subsets are non-overlapping. This allows making the separation of the data items into the anomaly classes more explicit.

In a further embodiment form of the first aspect, the subsets obtained based on the partial ranking of the data items further comprises a second subset comprising the data items falling outside of the at least two first subsets, and the at least one processor is further configured to select the probabilistic model taking into account the second subset. This makes the apparatus according to the first aspect more flexible in the sense that it can take account of the different anomaly classes when detecting one or more anomalies in the dataset.

In a further embodiment form of the first aspect, the data items of the second subset may be erroneously missed data items or data items having the anomaly scores differing from those of the data items belonging to the at least two first subsets. By doing so, it is feasible to provide the proper accuracy and robustness of anomaly detection even if there are data items mistakenly unranked or missed during the operation of the apparatus according to the first aspect.

In a further embodiment form of the first aspect, the interval of intermediate ranks of the second subset covers the intervals of intermediate ranks of the at least two first subsets. This means that the apparatus according to the first aspect is able to operate successfully even if the intermediate ranks of some data items are dispersed accidentally and arbitrarily in the whole interval of intermediate ranks.

In a further embodiment form of the first aspect, the predefined combination rule comprises the Dempster's rule of combination. This allows combining the degrees of belief entirely based on a statistical fusion approach rather than on the expert rules, thereby minimizing the user involvement to a greater extent and making the apparatus according to the first aspect easy to use.

In a further embodiment form of the first aspect, the at least two anomaly detection algorithms comprises any combination of the following algorithms: a nearest neighbor-based anomaly detection algorithm, a clustering-based anomaly detection algorithm, a statistical anomaly detection algorithm, a subspace-based anomaly detection algorithm, and a classifier-based anomaly detection algorithm. This provides additional flexibility in use because each of the algorithms listed above gives advantages when being applied in a certain usage domain.

In a further embodiment form of the first aspect, the degree of belief for the intermediate rank comprises a basic belief assignment. This allows increasing the accuracy of anomaly detection to a greater extent.

In a further embodiment form of the first aspect, the at least one processor is further configured to convert the total degrees of belief for the intermediate ranks of the data items to the probability distribution function by using a pignistic transformation, and the probability distribution function is a pignistic probability function. This allows increasing the accuracy of anomaly detection to a greater extent.

In a further embodiment form of the first aspect, the data items comprise network flow data, and the at least one anomalous data item relates to abnormal network flow behavior. This allows one to quickly detect and respond to a malicious activity or a device fault in a computer network.

According to a second aspect, a method for detecting an anomaly in a dataset is provided. The method is performed as follows. The dataset is received, which comprises multiple data items with at least one anomalous data item. Next, at least two anomaly detection algorithms are selected. By using each of the at least two anomaly detection algorithms, the following steps are performed: calculating an anomaly score for each of the data items; based on the anomaly scores, obtaining a partial ranking of the data items, the partial ranking causing the data items to be divided into subsets each corresponding to a different interval of intermediate ranks; based on the partial ranking, selecting a probabilistic model describing the intermediate ranks of the data items in each subset; and based on the probabilistic model, assigning a degree of belief to the intermediate rank of each of the data items in each subset. After that, a total degree of belief for the intermediate rank of each of the data items is obtained by combining the degrees of belief obtained, for this intermediate rank, by using all of the at least two anomaly detection algorithms in accordance with a predefined combination rule. Further, the total degrees of belief for the intermediate ranks of the data items are converted to a probability distribution function describing expected ranks of the data items. The data items are then sorted according to the expected ranks of the data items, and the at least one anomalous data item is eventually found among the sorted data items. By doing so, it is feasible to detect anomalies in more accurate and robust manner, without having to use expert rules specific to a particular knowledge domain.

According to a third aspect, a computer program product comprising a computer-readable storage medium storing a computer program is provided. The computer program, when executed by at least one processor, causes the at least one processor to perform the method according to the second aspect. Thus, the method according to the second aspect can be embodied in the form of the computer program, thereby providing flexibility in use thereof.

Other features and advantages of the present disclosure will be apparent upon reading the following detailed description and reviewing the accompanying drawings.

### BRIEF DESCRIPTION OF THE DRAWINGS

The essence of the present disclosure is explained below with reference to the accompanying drawings in which:

FIG. 1 illustrates one typical example of applying an anomaly detection algorithm to a dataset.

FIG. 2 shows an exemplary time histogram for numerical anomaly scores in case of malicious network activities.

FIG. 3 shows a block scheme of an apparatus for detecting an anomaly in a given dataset in accordance with an aspect of the present disclosure.

FIG. 4 shows an exemplary partial ranking obtained by the apparatus of FIG. 3.

FIG. 5 shows a probability distribution of intermediate ranks in the absence of unranked data items.

FIG. 6 shows the probability distribution of intermediate ranks in the presence of the unranked data items.

FIG. 7 shows an exemplary arrangement of the unranked data items among ranked data items.

FIG. 8 shows a block scheme of a method for detecting the anomaly in the dataset in accordance with another aspect of the present disclosure.

FIGS. 9A-9C shows the results of anomaly detection which are obtained by using a SVD-based anomaly detection algorithm (FIG. 9A), a clustering-based anomaly detection algorithm (FIG. 9B), and the method of FIG. 8 (FIG. 9C).

FIG. 10 shows the comparison results of a median rank aggregation method and the method of FIG. 8.

### DETAILED DESCRIPTION

Various embodiments of the present disclosure are further described in more detail with reference to the accompanying drawings. However, the present disclosure can be embodied in many other forms and should not be construed as limited to any certain structure or function disclosed in the following description. In contrast, these embodiments are provided to make the description detailed and complete.

According to the detailed description, it will be apparent to ones skilled in the art that the scope of the present disclosure encompasses any embodiment disclosed herein, irrespective of whether this embodiment is implemented independently or in concert with any other embodiment. For example, the apparatus and method disclosed herein can be implemented in practice by using any numbers of the embodiments provided herein. Furthermore, it should be understood that any embodiment can be implemented using one or more of the elements or steps presented in the appended claims.

As used herein, the term “anomaly” and its derivatives, such as “anomalous”, “abnormal”, etc., refer to something that deviates from what is standard, normal, or expected. In particular, the term “anomalous data item” also used herein means a data item in a dataset, which falls outside the ranges of the standard deviation of data items in the dataset. An anomaly may be characterized by two or more neighboring or close anomalous data items, and is called a collective anomaly in this case. The anomaly may relate to an event of interest, i.e. a problem to be detected and solved, or be irrelevant to the event of interest. In the latter case, the anomaly is called a spurious anomaly. One example of the anomaly includes a suspiciously large (i.e., non-typical) network flow which may be caused by malicious software. Although references are hereby made to network flow data, it should be apparent to those skilled in the art that this is done only by way of example but not limitation. In other words, the embodiments disclosed herein may be equally applied in other usage domains where anomaly detection is required, such, for example, as the detection of fraudulent pump and dump on stocks, the detection of excessive scores mistakenly issued in figure skating or other kinds of sports, etc.

The term “combination rule” used herein refers to an analytical rule or condition that may be applied to output data of multiple data sources to integrate the output data into more consistent, accurate, and useful information than the output data of any individual data source. The data sources are presented herein as anomaly detection algorithms, and their output data to be integrated or combined comprise degrees of beliefs. One example of the combination rule includes the Dempster's rule of combination.

The term “degree of belief” used herein refers to a mathematical object called a belief function that is used in the theory of belief functions, also known as the evidence theory or Dempster-Shafer theory. The theory of belief functions allows one to combine evidence from different data sources to arrive at a degree of belief that takes into account all the available evidence. As will be shown later, the degree of belief is applied herein to intermediate ranks of data items obtained by using the anomaly detection algorithms. One example of degrees of belief are basic belief assignments (bbas) which will be discussed later in context of the embodiments disclosed herein. By definition, assuming that θ represents a set of hypotheses H (for example, all possible states of a system under consideration), which is called a frame of discernment, the basic belief assignment represents a function assigning a belief mass m to each data element of a power set 2^{θ} which is a set of all subsets of θ, including an empty set Ø, such that m: 2^{θ}→[0,1]. The basic belief assignment has the following two main properties:

$$m ( ∅ ) = 0 , \\ {\sum }_{{H}_{n} ∈ θ} m ( {H}_{n} ) = 1 ,$$

where the subsets Hₙ of θ are called focal elements of m (non-zero masses).

As used herein, the term “rank” refers to a numerical parameter used to classify data items into different anomaly classes. Each anomaly class is represented by a certain interval of ranks. An intermediate rank discussed herein is obtained by using any one anomaly detection algorithm. An expected rank also discussed herein is a more valid rank resulted from using the intermediate ranks obtained by multiple anomaly detection algorithms.

FIG. 1 illustrates one typical example of applying an anomaly detection algorithm to a dataset 100. The dataset 100 includes data items 102a-102n and may relate to different usage domains. For example, the data items may comprise log messages communicated by one or more network devices. In this case, an anomaly may occur, which consists in rapidly increasing the number of the log messages communicated per time unit due to harmful third-party intervention. To detect the anomaly, the anomaly detection algorithm calculates an anomaly score for each of the data items 102a-102n and assigns certain anomaly classes to the data items based on the anomaly scores. Each anomaly class is characterized by a specified interval of the anomaly scores. The anomaly scores may be real number or ordered factor variables. The larger anomaly scores correspond to more anomalous data items. In particular, the data items 102a-102n may be separated into two classes 104a and 104b, i.e. simply “normal” and “anomalous” data items, or the classification may be more complex. In the latter case, the anomaly scores corresponding each class may be defined along an anomaly score axis 106 such that there are more than two anomaly classes 108a-108d comprising, for example, “common”, “unusual”, “very usual”, and “extremely unusual” data items. Indeed, the number of the anomaly classes may vary depending on the type of the anomaly detection algorithm (which will be discussed later). Although such classification is shown in FIG. 1 only for the data item 102k, this is done for the sake of simplicity and it should be apparent that the same classification is provided for each of the data items 102a-102n.

FIG. 2 shows an exemplary time histogram for numerical anomaly scores, as expected for use in detecting malicious network activities. The anomaly scores have been obtained by applying a Singular Value Decomposition (SVD)-based anomaly detection algorithm to the log messages communicated by the network device. In particular, the SVD-based anomaly detection algorithm has used frequencies of state changes extracted from the log messages as the main feature of the malicious network activities and assigned the anomaly scores to certain time intervals. The highest spikes are good candidates for the malicious network activities that have to be localized using the anomaly detection algorithm. As can be seen from FIG. 2, there are the four highest spikes 200a-200d to be considered. As for a line 202, it denotes the actual time of occurrence of the malicious network activities. The line 202 is closer to the fourth spike 200d, for which reason the fourth spike 200d should be only taken into account. As for the spikes 200a-200c, these are irrelevant to the event of interest, i.e. correspond to the spurious anomalies, and should be excluded from consideration in this example. However, by using only one anomaly detection algorithm, it is impossible to arrive at the conclusion that the spikes 200a-200c are not related to the malicious network activities. It should be noted that a similar time histogram may be used to detect any other problem occurring in network communications, instead of the malicious network activities, and, for example, the line 202 may relate to any network device malfunctions.

Generally speaking, the absolute values of the anomaly scores themselves are meaningless—they are used solely for establishing the ordering relationship among the data items. Therefore, the accuracy of anomaly detection is low in cases of using only one anomaly detection algorithm.

The aspects of the present disclosure discussed below take into account the above-mentioned drawbacks, and are directed to improving the accuracy and robustness of anomaly detection, particularly, in the network flow data.

FIG. 3 shows an exemplary block scheme of an apparatus 300 for detecting an anomaly in a given dataset, for example, like that shown in FIG. 1, in accordance with an aspect of the present disclosure. As shown in FIG. 3, the apparatus 300 comprises a storage 302 and a processor 304 coupled to the storage 302. The storage 302 stores executable instructions 306 to be executed by the processor 304 to detect the anomaly in the dataset. It is intended that the dataset comprises at least one anomalous data item.

The storage 302 may be implemented as a volatile or nonvolatile memory used in modern electronic computing machines. Examples of the nonvolatile memory include Read-Only Memory (ROM), flash memory, ferroelectric Random-Access Memory (RAM), Programmable ROM (PROM), Electrically Erasable PROM (EEPROM), solid state drive (SSD), magnetic disk storage (such as hard drives and magnetic tapes), optical disc storage (such as a compact disc (CD), digital vide disc (DVD) and Blu-ray discs), etc. As for the volatile memory, examples thereof include Dynamic RAM, Synchronous DRAM (SDRAM), Double Data Rate SDRAM (DDR SDRAM), Static RAM, etc.

Relative to the processor 304, it may be implemented as a central processing unit (CPU), general-purpose processor, single-purpose processor, microcontroller, microprocessor, application specific integrated circuit (ASIC), field programmable gate array (FPGA), digital signal processor (DSP), complex programmable logic device, etc. It should be also noted that the processor 304 may be implemented as any combination of one or more of the aforesaid. As an example, the processor 304 may be a combination of two or more microprocessors.

The executable instructions 306 stored in the storage 302 may be configured as a computer executable code which causes the processor 304 to perform the aspects of the present disclosure. The computer executable code for carrying out operations or steps for the aspects of the present disclosure may be written in any combination of one or more programming languages, such as Java, C++ or the like. In some examples, the computer executable code may be in the form of a high level language or in a pre-compiled form, and be generated by an interpreter (also pre-stored in the storage 302) on the fly.

Being caused with the executable instructions 306, the processor 304 first receives the dataset comprising multiple data items among which the at least one data item is anomalous, as noted above. After that, the processor 304 selects at least two anomaly detection algorithms based on the usage domain which the data items belong to. The reason for using two or more anomaly detection algorithms is a synergic effect consisting in that the accuracy of anomaly detection provided by the two or more anomaly detection algorithms is higher than that provided by any single anomaly detection algorithm. More specifically, if a user of the apparatus 300 is absolutely sure that one of the anomaly detection algorithms provides 100% accuracy, he or she will not combine it with any other of the anomaly detection algorithms. However, in practice, any anomaly detection algorithm is prone to errors, which forces the user to decide which of the anomaly detection algorithms has to be selected and under what circumstances. That is why the aggregated accuracy provided by the two or more anomaly detection algorithms is more preferable and useful in the process of anomaly detection.

In one embodiment, the at least two anomaly detection algorithms comprise any combination of the following algorithms: a nearest neighbor-based anomaly detection algorithm, a clustering-based anomaly detection algorithm, a statistical anomaly detection algorithm, a subspace-based anomaly detection algorithm, and a classifier-based anomaly detection algorithm. Some examples of such anomaly detection algorithms are described by Goldstein M. and Uchida S. in their work “A Comparative Evaluation of Unsupervised Anomaly Detection Algorithms for Multivariate Data”, PLoS ONE 11(4): e0152173 (2016). Moreover, the at least two anomaly detection algorithms may be unsupervised or supervised learning based anomaly detection algorithms, thereby making the apparatus 300 more automatic and flexible in use. As should apparent to those skilled in the art, unsupervised or supervised learning may involve using neural networks, decision trees, and/or other artificial intelligence techniques, depending on particular applications.

Once the at least two anomaly detection algorithms are selected, the processor 304 uses them to calculate the anomaly score for each of the data items. The anomaly scores are then used by the processor 304 to obtain a partial ranking of the data items. The partial ranking causes the data items to be divided into subsets each corresponding to a different interval of intermediate ranks, as schematically shown in FIG. 4. More specifically, the partial ranking shown in FIG. 4 is defined by specifying ordered subsets 400a-400c (graphically shown as buckets) each filed with the corresponding data items. The subsets 400a-400c do not overlap with each other in the sense that any data item of one subset cannot simultaneously belong to another subset. The subsets 400a-400c correspond to particular anomaly classes like those discussed above with reference to FIG. 1. In other words, the subsets 400a-400c may be constituted by “very unusual”, “unusual” and “common” data items, respectively. With such subsets, the height (i.e., rank) of any data item in the “unusual” subset is less that the height (i.e., rank) of any data item in the “common” subset while the relative heights (i.e., ranks) of the data items within each subset is indefinite (this is the reason why the ranking is called “partial”). The easiest way to achieve the partial ranking is to assign the data items with the same anomaly scores to the corresponding subset and arrange the subsets in the reverse order of their anomaly scores. It should be apparent to those skilled in the art that the number of the subsets may be more than three, depending on the capabilities of the anomaly detection algorithms used.

By using the partial ranking, the processor 304 further selects a probabilistic model describing the intermediate ranks of the data items in each of the subsets. In general, the probabilistic model defines a probability distribution of the intermediate ranks among the data items in each subset. FIG. 5 shows one example of the partial ranking, in which there are two non-overlapping subsets 500a and 500b formed by all the data items of the dataset. Then, one may postulate the uniform probability distribution of the intermediate ranks for each of the subsets 500a and 500b—these two distributions Pₐ and P_{b} will be adjacent. Such uniform probability distributions correspond to an ideal case and hardly occur in practice.

However, if there are not all the data items put in the non-overlapping subsets either mistakenly or due to the presence of the data items having the anomaly scores other than those of the data items put in the non-overlapping subsets, the uniform probability distributions for the non-overlapping subsets will be violated. This situation is schematically shown in FIG. 6, where it is intended that two non-overlapping subsets 600a and 600b correspond to the “unusual” and “common” anomaly classes, respectively, and the rest data items, i.e. those unassigned to the subsets 600a and 600b and thus having unknown intermediate ranks, fill a full height subset 600c which spreads along the subsets 600a and 600b. Then, one may postulate a uniform probability distribution Pc of the intermediate ranks for the data items in the subset 600c. This postulation will reshape the probability distributions Pₐ, P_{b} of the intermediate ranks for the subsets 600a and 600b—they will become less angular and start overlapping.

To calculate the probability distribution of the intermediate ranks in the subset of interest in the presence of the unranked data items, the processor 304 may be configured to perform the following procedure. At first, let us assume that, as a result of the partial ranking, there are an arbitrary number of ranked subsets (i.e., buckets), like the subsets 600a and 600b in FIG. 6, and one subset (i.e., bucket) filled with the unranked data items, like the subset 600c in FIG. 6. Further, it is assumed that the probability distribution of intermediate ranks for the data items from one of the ranked subsets is of great interest and has to be calculated. Let such a ranked subset be denoted as an j-th subset. The situation assumed above is schematically shown in FIG. 7, where textured circles represent the data items of the j-th subset, white circles represent the data items of other ranked subsets (which are not of interest as they comprise the “common” or less anomalous data items, for example), and black circles represent the unranked data items. Given such arrangement of the circles, the processor 304 may be additionally configured to divide the circles into three groups—“top”, “middle”, and “bottom”—with the middle group comprising all the data items of the j-th subset and some of the unranked data items, and with the top and bottom groups comprising the remaining of the unranked data items and all the data items belonging to the ranked subsets, except the j-th subset. The three groups thus constructed can be characterized by the following parameters:
1) N—the number of the ranked data items in the ranked subsets, N=Σᵢ₌₁^{N}^{_{B}}|Bᵢ|=|X|−K, where |X| is the number of the data items in the dataset X, N_{B} is the number of the ranked subsets, Bᵢ is the corresponding ranked subset, and K=|B_{Θ}| is the number of the unranked data items constituting the subset B_{Θ};
2) n_{middle}—the number of the data items in the middle group;
3) nₜₒₚ—the number of the data items in the top group;
4) n_{bottom}—the number of the data items in the bottom group;
5) k_{middle}—the number of the unranked data items (i.e. the black circles) in the middle group,

$${k}_{middle} = \vert \{ x ∈ {B}_{Θ} \vert {min}_{y ∈ {B}_{j}} r a n k ( y ) < r a n k ( x ) < {max}_{z ∈ {B}_{j}} r a n k ( z ) \} \vert ,$$

where B₁ denotes the j-th subset, y and z are the left and right boundary data items, respectively, in the middle group, and x is the unranked data item;
6) kₜₒₚ—the number of the unranked data items (i.e. the black circles) in the top group,

$${k}_{t o p} = \vert \{ x ∈ {B}_{Θ} \vert r a n k ( x ) < {min}_{y ∈ {B}_{j}} r a n k ( y ) \} \vert ;$$

7) k_{bottom}—the number of the unranked data items (i.e. the black circles) in the bottom group,

$${k}_{b o t t o m} = \vert \{ x ∈ {B}_{Θ} \vert r a n k ( x ) > {max}_{γ ∈ {B}_{j}} rank ( y ) \} \vert .$$

Further, the processor 304 uses a pseudo code for computing the probability distribution P₁ of the intermediate ranks of the data items in B₁, which is given below as Algorithm 1. It is assumed that Pⱼ is the |X|-component vector such that Pⱼ(r)=Pr(rank(x)=r) for any x∈Bⱼ and r∈{1, . . . , |X|}. By definition, Σᵣ₌₁^{|X|}Pⱼ(r)=1.

```
Algorithm 1: Compute the probability distribution of the intermediate
ranks for the data items in Bⱼ.
  Inputs: |X|, N, n_{middle}, n_{bottom}, nₜₒₚ, K, k_{middle}, k_{bottom}, kₜₒₚ
  Output: Pⱼ
  Pⱼ(1: |X|) ← 0
  for all possible pairs (rₜₒₚ, r_{bottom}) do
    p_{middle} ← HYP(k_{middle}, n_{middle}, K, N)
    p_{bottom} ← HYP(k_{bottom}, n_{bottom}, K − k_{middle}, N − n_{middle})
    pₜₒₚ ← Hyp(kₜₒₚ, nₜₒₚ, K − k_{bottom} − k_{middle}, N − n_{bottom} − n_{middle})
    p_{decomp} ← pₜₒₚ * p_{middle} * p_{bottom}
    p_{uniform} ← 1/n_{middle}
    Pⱼ (rₜₒₚ:r_{bottom}) ← Pⱼ (rₜₒₚ:r_{bottom}) + p_{uniform} * p_{decomp}
  end for
```

In Algorithm 1, p_{decomp} is the probability of the decomposition of the unranked data items, which is defined by the parameters k_{middle}, k_{bottom}, kₜₒₚ, the sign “←” is the value assignment operator, and the function Hyp( ) is the hypergeometric distribution. In particular, the function Hyp( ) describes the probability of obtaining the total number of k black circles in the sample of length n without replacement, starting out with N circles among which K circles are black. In other words,

$$H y p ( k , n , K , N ) = \frac{{c}_{K}^{k} {c}_{N - K}^{n - k}}{{c}_{N}^{n}} ,$$

where C_{K}^{k} is the binomial coefficient.

Thus, by using Algorithm 1, the processor 304 calculates the probability distribution Pⱼ of the intermediate ranks of the data items in Bⱼ in case of using each of the at least two anomaly detection algorithms. In other words, if the processor 304 uses L anomaly detection algorithms, it will be required for the processor 304 to calculate the probability distributions Pⱼ⁽¹⁾, . . . , Pⱼ^{(L)} respectively, for the intermediate ranks of the data items in Bⱼ.

When the probabilistic model, or, in other words, the probability distribution Pⱼ, is calculated, the processor 304 further assigns, the based on Pⱼ, a degree of belief to the intermediate rank of each of the data items in B₁. Further, the degree of belief is exemplified by the basic belief assignment (bba). However, the degree of belief is not limited to the bba, and may be presented as any other belief functions specific to the Dempster-Shafer theory.

In one embodiment, the processor 304 is configured to provide each of the at least two anomaly detection algorithms with a different weight coefficient and assign the bba based on the probabilistic model in concert with the weight coefficient of the anomaly detection algorithm. This allows adjusting the contribution of each anomaly detection algorithm into the aggregated accuracy of anomaly detection.

In one embodiment, in case of the unsupervised learning based anomaly detection algorithms, the processor 304 is configured to specify the different weight coefficients of the at least two anomaly detection algorithms based on user preferences such that the sum of the weight coefficients is equal to 1, i.e. Σᵢ₌₁wᵢ=1, where L is the number of the anomaly detection algorithms used. This allows the user of the apparatus 300 to prioritize the anomaly detection algorithms according to his or her experience.

In another embodiment, in case of the supervised learning based anomaly detection algorithms, the processor 304 is configured to adjust the weight coefficients of the at least two anomaly detection algorithms by using a pre-arranged training set comprising different previous datasets and target rankings each corresponding to one of the previous datasets. The training set may be stored in the storage 302 in advance, i.e. before the operation of the apparatus 300. In this case, the processor 304 first searches for the previous dataset similar to that of interest, and then changes the weight coefficient of each anomaly detection algorithm until the partial ranking coincides with the target ranking of this previous dataset. The weight coefficients of the at least two anomaly detection algorithms may be further adjusted by the processor 304 based on the Kendall tau distance serving a measure of distance between the combined partial rankings obtained by the at least two anomaly detection algorithms and respective one of the target rankings from the training set. In this case, the Kendall tau distance, which exploits a probability distribution similar to Pⱼ calculated earlier, for a pair of partial rankings σ and τ are expressed as follows (here the signs “∨” and “∧” represent the grouping and intersection signs, respectively):

$$\tilde{K} ( σ , τ ) = {\sum }_{i < j} Pr [ ( σ ( i ) < σ ( j ) ⩓ τ ( i ) > τ ( j ) ⩔ ( σ ( i ) > σ ( j ) ⩓ τ ( i ) < τ ( j ) ) ] ,$$

and its normalized analogue is given by

$$\overline{K} ( σ , τ ) = \frac{2 \tilde{K} ( σ , τ )}{\vert X \vert ( \vert X \vert - 1 )} .$$

Being governed by M training sets, the weight coefficient adaptation procedure strives to find non-negative weight coefficients w₁, . . . , w_{L} which minimize the following loss function:

$${\sum }_{i = 1}^{L} \overline{K} ( {σ}_{gr . truth}^{i} , {w}_{1} {τ}_{1}^{i} + ⋯ + {w}_{L} {τ}_{L}^{i} ) ,$$

and satisfy the condition Σₗ₌₁^{L}wₗ=1. Here σ_{gr.truth}ⁱ is the partial ranking that is known to be true for the data items in the i-th training set, τₗⁱ is the partial ranking computed by the l-th anomaly detection algorithm for the data items in the i-th training set, w₁τ₁ⁱ+ . . . +w_{L}τ_{L}ⁱ is the partial ranking obtained by the processor 304, i.e. by combining the partial rankings τ₁ⁱ, . . . , τ_{L}ⁱ with the weight coefficients w₁, . . . , w_{L}.

Turning now back to the assignment of the bbas, it should be noted that the processor 304 may use Algorithm 2 for this purpose, which is given below and takes into account the weight coefficients of the anomaly detection algorithms.

```
Algorithm 2: Compute the bba for the data item x ranked by the l-th
anomaly detection algorithm.
  Input: P^{(l)}
  Output: mₗ
  for r=1:|X| do
    mₗ(rank(x) = r) ← wₗ * P^{(l)}(r)
  end for
  mₗ(rank(x) = 1 ∪ ... ∪ rank(x) = |X|) ← 1 − wₗ
```

In other words, by using Algorithm 2, the processor 304 considers the following frame of discernment 0={rank(x)=1, . . . , rank(x)=|X|} for each data item, and computes (|X|+1)-component bbas, with the components corresponding to the following outcomes rank(x)=1, . . . , rank(x)=|X|, rank(x)=Θ. The last outcome, i.e. rank(x)=Θ, means that x may have any intermediate rank. By construction, Σₗmₗ=1.

When the bbas for all the anomaly detection algorithms are obtained, the processor 304 then obtains a total degree of belief, i.e. a total bba, for the intermediate rank of each of the data items. To do this, the processor 304 combines the bbas obtained for the intermediate rank in accordance with a predefined combination rule. Algorithm 3 given below describes this operation, taking the Dempster's rule of combination as one example of the predefined combination rule.

Algorithm 3: Apply the Dempster's rule of combination
to the data item x.

Input: m₁, m₂
Output m_{1,2}
for each outcome A do
${m}_{1 , 2} ( A ) = {\sum }_{B ⋂ C = A} {m}_{1} ( B ) \cdot {m}_{2} ( C ) \text{/} ( 1 - {\sum }_{B ⋂ C = ∅} {m}_{1} ( B ) \cdot {m}_{2} ( C ) )$
end for

In Algorithm 3, A, B, C are the indices that can take on any value from 1 to |X|+1, and m_{1,2}, m₁, and m₂ are the vectors of length |X|+1, with m₁, and m₂ corresponding to the first and the second anomaly detection algorithms, respectively, the results of which are subjected to combination, and m_{1,2} being the result of this combination. Since the Dempster's rule of combination is both commutative and associative, it can combine all L bbas (according to the number of the anomaly detection algorithms) in a single total bba m.

After that, the processor 304 converts the total bbas for the intermediate ranks of the data items to a probability distribution function describing expected ranks of the data items. This may be done in one embodiment by using a pignistic transformation, and the probability distribution function is a pignistic probability function betP in such case. The pignistic transformation performed by the processor 304 is generalized below as Algorithm 4.

```
Algorithm 4: Compute the pignistic probability betP for the data item x.
  Input: m
  Output: betP
  for r in 1:|X| do
    betP(r) ← m(rank(x) = r)
      + m(rank(x) = 1 ∪ ... ∪ ∪ rank(x) = |X|)/|X|
  end for
```

Next, the processor 304 computes the expected rank of each data item x∈X by using the pignistic probability betP and sorts all the data items in the dataset X by their expected ranks according to the following formula:

E[rank(x)]=Σᵣ₌₁^{|X|}r·betP(r).

Finally, the processor 304 finds the at least one anomalous data item among the sorted data items. Thus, by using the above-described procedure comprising Algorithms 1-4, the processor 304 is able to detect the anomaly of interest in the dataset, and even filter out the spurious anomalies if they are present in the dataset.

In one embodiment, the processor 304 may further convert the expected ranks to the partial ranking in the same way as the original anomaly scores are converted to the partial rankings but with the reverse order of the subsets because, by convention, the smaller ranks should correspond to the higher anomaly scores.

With reference to FIG. 8, a method 800 for detecting an anomaly in a dataset will be now described in accordance with another aspect of the present disclosure. In embodiments, the method 800 represents operations of the apparatus 300, and each step of the method 800 may be performed by the processor 304 included in the apparatus 300.

The method 800 starts up in step 802, in which the dataset comprising at least one anomalous data item is received. As noted earlier, the dataset may relate to different usage domains. Once the dataset is received, the method proceeds to step 804, in which the at least two anomaly detection algorithms are selected based on the usage domain which the dataset belongs to. Further, steps 806-812 are carried out by using each of the at least two anomaly detection algorithms independently.

In particular, an anomaly score for each of the data items is calculated in the step 806. In the step 808, a partial ranking of the data items is obtained based on the anomaly scores. The partial ranking represents the division of the data items into subsets each corresponding to a different interval of intermediate ranks and, consequently, a different anomaly class. The examples of such subsets have been discussed above with reference to FIGS. 4-6. The subsets obtained based on the partial ranking of the data items may comprise at least two first subsets, for example, with one having normal data items and another having anomalous data items. Each of the at least two first subsets may be composed of the data items having the same anomaly scores. The intervals of intermediate ranks of the at least two first subsets are non-overlapping in the sense that the same data item cannot belong to different two or more of the first subsets simultaneously. In case if there are unranked data items, i.e. those falling outside of the at least two first subsets either mistakenly or due to their anomaly scores, the subsets obtained based on the partial ranking of the data items may additionally comprise a second subset comprising the unranked data items. The interval of intermediate ranks of the second subset covers the intervals of intermediate ranks of the at least two first subsets. Next, the method 800 proceeds to step 810, in which a probabilistic model is selected based on the partial ranking. The probabilistic model describes the intermediate ranks of the data items in each subset, and may be calculated by using Algorithm 1 discussed above. After that, by using the probabilistic model, in the step 812, a degree of belief is assigned to the intermediate rank of each of the data items in each subset. One example of the degree of belief is the bba which may be calculated by using Algorithm 2 discussed above.

Once the degrees of belief for each intermediate rank are obtained by using each of the at least two anomaly detection algorithms, the method 800 proceeds to step 814, in which the degrees of belief are combined in accordance with the combination rule to obtain a total degree of belief. This may be done by using Algorithm 3 discussed above, in which the combination rule is exemplified by the Dempster's rule of combination. Further, in step 816, the total degrees of belief for the intermediate ranks of the data items are converted to a probability distribution function describing expected ranks of the data items. Such conversion may be implemented by using the pignistic transformation described above with reference to Algorithm 4. After that, the data items are sorted, in step 818, according to the expected ranks of the data items. Finally, in step 820, the at least one anomalous data items is found among the sorted data items.

FIGS. 9A-9C demonstrate how the method 800 can help in attenuating the spurious anomalies found by the anomaly detection algorithms and, consequently, detecting the anomaly of interest. In this practical example, it is intended that the anomaly of interest corresponds to a fault in a router, and the goal of the method 800 is to trace the fault based on the log messages produced by the router. To do this, two different anomaly detection algorithms, i.e. the SVD-based anomaly detection algorithm and the clustering anomaly detection algorithm, have been used to divide a given period of time into small time intervals and compute the anomaly scores for the time intervals, with the higher anomaly scores corresponding to more anomalous log messages. The time interval corresponding to the anomaly of interest, i.e. the fault, is denoted as 900 in FIGS. 9A-9C, and the bar or spike closer to the time interval 900 is denoted as 902. The results of the SVD-based anomaly detection algorithm are shown in FIG. 9A, where an unexpectedness represents an anomaly degree of network state which is calculated based on the log messages produced by the router. As can be seen from FIG. 9A, a time histogram for the unexpectedness comprises the three highest spikes 904-908 which correspond to the spurious anomalies and higher than the target spike 902. Thus, the user would face difficulties in detecting the anomaly of interest if he or she relied only on the results of the SVD-based anomaly detection algorithm. FIG. 9B shows another histogram for a number of new log messages produced by the router per certain time interval. Again, the user could not find the anomaly of interest based solely on the histogram shown in FIG. 9B because there is the highest spike 910 corresponding to the spurious anomaly. Finally, FIG. 9C represents a time histogram for an inverted expected rank, i.e. |X|−E[rank(x)], obtained by using the method 800. More specifically, the results shown in FIG. 9C are obtained by combining the SVD-based anomaly detection algorithm and the clustering anomaly detection algorithm together with the equal weight coefficients (w₁=w₂=0.5). One can see that the target spike 902 is the first highest spike coinciding with the time interval 900. Thus, the method 800 successfully strengthened the target spike 902 that corresponds to the fault, while damping the spurious anomalies represented by the spikes 904-910.

It should be noted that some approaches suggest an alternative solution for the same problem which is addressed by the method 800 using the Dempster's rule of combination. In particular, the alternative solution involves adopting a median rank aggregation to partial rankings. However, the median rank aggregation method provides a lower accuracy of anomaly detection compared to the accuracy of the method 800. This has been proved by numerical experiments, the results of which are shown in FIG. 10. In particular, both of the methods have used |X|=100 data items and L=10 anomaly detection algorithms. The random partial rankings have been generated as having up to N_{B}=30 subsets (“buckets”), and each partial ranking has been disturbed L=10 times by combining it with random permutations. Then, the original undisturbed partial ranking has been reconstructed by using either the method 800 or the median rank aggregation method, and the distance between the reconstructed and the original partial rankings has been calculated by using the normalized Kendall tau distance K. Additionally, the mean value of the same distance between the disturbed and the original partial rankings has been calculated, with the mean value of the same distance being larger than K. FIG. 10 shows how the difference between the two distances depends on the degree of disturbance. One can see that the method 800 outreached the median rank aggregation method, irrespective of the degree of disturbance. The same result has been observed for any other values of the parameters |X|, L and N_{B}.

Those skilled in the art should understand that each step of the method 800, or any combinations of the steps, can be implemented by various means, such as hardware, firmware, and/or software. As an example, one or more of the steps described above can be embodied by computer or processor executable instructions, data structures, program modules, and other suitable data representations. Furthermore, the computer executable instructions which embody the steps described above can be stored on a corresponding data carrier and executed by at least one processor like the processor 304 included in the apparatus 300. This data carrier can be implemented as any computer-readable storage medium configured to be readable by said at least one processor to execute the computer executable instructions. Such computer-readable storage media can include both volatile and nonvolatile media, removable and non-removable media. By way of example, and not limitation, the computer-readable media comprise media implemented in any method or technology suitable for storing information. In more detail, the practical examples of the computer-readable media include, but are not limited to information-delivery media, RAM, ROM, EEPROM, flash memory or other memory technology, CD-ROM, DVD, holographic media or other optical disc storage, magnetic tape, magnetic cassettes, magnetic disk storage, and other magnetic storage devices.

Although the exemplary embodiments are disclosed herein, it should be noted that any various changes and modifications could be made in these embodiments, without departing from the scope of legal protection which is defined by the appended claims. In the appended claims, the mention of elements in a singular form does not exclude the presence of the plurality of such elements, if not explicitly stated otherwise.

1. An apparatus for detecting an anomaly in a dataset, the apparatus comprising:
at least one processor; and
a storage coupled to the at least one processor and storing executable instructions which, when executed by the at least one processor, cause the at least one processor to:
receive the dataset comprising multiple data items among which at least one data item is anomalous,
process the data items in the data set by each of at least two of a plurality of anomaly detection algorithms to:
calculate an anomaly score for each of the data items,
based on the anomaly scores, obtain a partial ranking of the data items, the partial ranking causing the data items to be divided into subsets each corresponding to a different interval of intermediate ranks,
based on the partial ranking, select a probabilistic model describing the intermediate ranks of the data items in each subset, and
based on the probabilistic model, assign a degree of belief to the intermediate rank of each of the data items in each subset,
obtain a total degree of belief for the intermediate rank of each of the data items by combining the degrees of belief obtained, for intermediate ranks corresponding to each of the data items, from the at least two anomaly detection algorithms in accordance with a predefined combination rule,
convert the total degrees of belief for the intermediate ranks of the data items to a probability distribution function describing expected ranks of the data items,
sort the data items according to the expected ranks of the data items, and
find, among the sorted data items, the at least one anomalous data item.

2. The apparatus of claim 1, wherein the at least one processor is further configured to select the at least two anomaly detection algorithms from the plurality of anomaly detection algorithms based on a usage domain which the data items belong to.

3. The apparatus of claim 1, wherein each of the at least two anomaly detection algorithms is provided with a different weight coefficient, and wherein the at least one processor is further configured to assign the degree of belief based on the probabilistic model in concert with the weight coefficient of the anomaly detection algorithm.

4. The apparatus of claim 3, wherein the at least two anomaly detection algorithms are unsupervised learning based anomaly detection algorithms, and wherein the different weight coefficients of the at least two anomaly detection algorithms are specified based on user preferences such that the sum of the weight coefficients is equal to 1.

5. The apparatus of claim 3, wherein the at least two anomaly detection algorithms are supervised learning based anomaly detection algorithms, and wherein the weight coefficients of the at least two anomaly detection algorithms are adjusted by using a pre-arranged training set comprising different previous datasets and target rankings each corresponding to one of the previous datasets.

6. The apparatus of claim 5, wherein the weight coefficients of the at least two anomaly detection algorithms are further adjusted based on a Kendall tau distance serving a measure of distance between the combined partial rankings obtained by the at least two anomaly detection algorithms and a respective one of the target rankings from the training set.

7. The apparatus of claim 1, wherein the subsets obtained based on the partial ranking of the data items comprise at least two first subsets each comprising the data items having the same anomaly scores.

8. The apparatus of claim 7, wherein the intervals of intermediate ranks of the at least two first subsets are non-overlapping.

9. The apparatus of claim 7, wherein the subsets obtained based on the partial ranking of the data items further comprise a second subset comprising data items falling outside of the at least two first subsets, and the at least one processor is further configured to select the probabilistic model taking into account the second subset.

10. The apparatus of claim 9, wherein the data items of the second subset are erroneously missed data items.

11. The apparatus of claim 9, wherein the data items of the second subset are data items having the anomaly scores differing from those of the data items belonging to the at least two first sub sets.

12. The apparatus of claim 9, wherein the data items of the second subset are erroneously missed data items and data items having the anomaly scores differing from those of the data items belonging to the at least two first subsets.

13. The apparatus of claim 9, wherein the interval of intermediate ranks of the second subset covers the intervals of intermediate ranks of the at least two first subsets.

14. The apparatus of claim 1, wherein the predefined combination rule comprises Dempster's rule of combination.

15. The apparatus of claim 1, wherein the at least two anomaly detection algorithms comprises any combination of the following algorithms: a nearest neighbor-based anomaly detection algorithm, a clustering-based anomaly detection algorithm, a statistical anomaly detection algorithm, a subspace-based anomaly detection algorithm, and a classifier-based anomaly detection algorithm.

16. The apparatus of claim 1, wherein the degree of belief for the intermediate rank comprises a basic belief assignment.

17. The apparatus of claim 1, wherein the at least one processor is further configured to convert the total degrees of belief for the intermediate ranks of the data items to the probability distribution function by using a pignistic transformation, and wherein the probability distribution function is a pignistic probability function.

18. The apparatus of claim 1, wherein the data items comprise network flow data, and the at least one anomalous data item relates to abnormal network flow behavior.

19. A method for detecting an anomaly in a dataset, the method comprising:
receiving the dataset comprising multiple data items among which at least one data item is anomalous,
processing the data items in the data set by each of at least two of a plurality of anomaly detection algorithms by:
calculating an anomaly score for each of the data items,
based on the anomaly scores, obtaining a partial ranking of the data items, the partial ranking causing the data items to be divided into subsets each corresponding to a different interval of intermediate ranks,
based on the partial ranking, selecting a probabilistic model describing the intermediate ranks of the data items in each subset, and
based on the probabilistic model, assigning a degree of belief to the intermediate rank of each of the data items in each subset,
obtaining a total degree of belief for the intermediate rank of each of the data items by combining the degrees of belief obtained, for intermediate ranks corresponding to each of the data items, from the at least two anomaly detection algorithms in accordance with a predefined combination rule,
converting the total degrees of belief for the intermediate ranks of the data items to a probability distribution function describing expected ranks of the data items,
sorting the data items according to the expected ranks of the data items, and
finding, among the sorted data items, the at least one anomalous data item.

20. A computer program product comprising a computer-readable storage medium storing a computer program, the computer program, when executed by at least one processor, causing the at least one processor to perform operations, comprising:
receiving the dataset comprising multiple data items among which at least one data item is anomalous,
processing the data items in the data set by each of at least two of a plurality of anomaly detection algorithms by:
calculating an anomaly score for each of the data items,
based on the anomaly scores, obtaining a partial ranking of the data items, the partial ranking causing the data items to be divided into subsets each corresponding to a different interval of intermediate ranks,
based on the partial ranking, selecting a probabilistic model describing the intermediate ranks of the data items in each subset, and
based on the probabilistic model, assigning a degree of belief to the intermediate rank of each of the data items in each subset,
obtaining a total degree of belief for the intermediate rank of each of the data items by combining the degrees of belief obtained, for intermediate ranks corresponding to each of the data items, from the at least two anomaly detection algorithms in accordance with a predefined combination rule,
converting the total degrees of belief for the intermediate ranks of the data items to a probability distribution function describing expected ranks of the data items,
sorting the data items according to the expected ranks of the data items, and
finding, among the sorted data items, the at least one anomalous data item.
